(19) United States
(12) Patent Application Publication
(10) Pub. No.: US 2008/0311450 A1
(43) Pub. Date: Dec. 18, 2008

(54) COOLING APPARATUS FOR FUEL CELL

(76) Inventor: Masahiro Inoue, Gotenba-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/137,599

(22) Filed: Jun. 12, 2008

(30) Foreign Application Priority Data
Jun. 15, 2007 (JP) 2007-159156

(51) Int. Cl. H01M 8/04

(52) U.S. Cl. 429/22

(57) ABSTRACT

To provide a cooling apparatus that restrains a rise in conductivity of a cooling medium. A cooling apparatus for a fuel cell includes cooling piping through which a cooling medium for cooling the fuel cell flows, a conductivity measuring unit measuring a conductivity of the cooling medium that flows through the cooling piping, a conductivity reducing agent supply unit supplying the cooling piping with a conductivity reducing agent for reducing the conductivity of the cooling medium, and a control unit controlling the conductivity reducing agent supply unit in accordance with a value of the measured conductivity.

### BACKGROUND OF THE INVENTION

The present invention relates to a cooling apparatus for a fuel cell that produces water when generating power.

If a fuel cell system is employed for a long period of time, ions get eluted into a cooling medium (e.g., cooling water, a cooling liquid, a cooling system coolant) from within cooling system piping, a radiator and the fuel cell. An electrical conductivity of the cooling medium consequently rises, and there is a possibility that an electric leak occurs. For ensuring safety, the ions eluted into the cooling system piping are trapped (accumulated up) by disposing an ion exchanger in the cooling system piping, thus restraining the electrical conductivity from rising.
[Patent document 1] Japanese Unexamined Patent Application Publication No. 2005-209435
[Patent document 2] WO 2003/094271

### SUMMARY OF THE INVENTION

In the case of disposing the ion exchanger in order to restrain the rise in the electrical conductivity of the cooling medium, however, it is required to ensure a broad mounting space for disposing the ion exchanger. Further, a complicated operation for exchanging the ion exchanger is periodically needed, and hence a high labor charge occurs. A ratio at which a size or a weight of the ion exchanger occupies the whole components of the fuel cell system is not at an ignorable level, and hence there exists a demand for building up the fuel cell system involving none of the ion exchanger. The present invention aims at providing a cooling apparatus that restrains a rise in the conductivity of the cooling medium.

The present invention adopts the following means in order to solve the problems given above. Namely, the present invention is a cooling apparatus for a fuel cell, comprises cooling piping through which a cooling medium for cooling the fuel cell flows, a conductivity measuring unit measuring a conductivity of the cooling medium that flows through the cooling piping, a conductivity reducing agent supply unit supplying the cooling piping with a conductivity reducing agent for reducing the conductivity of the cooling medium, and a control unit controlling the conductivity reducing agent supply unit in accordance with a value of the measured conductivity. According to the present invention, whether the supply of the conductivity reducing agent to the cooling piping is required or not is determined based on a value of the conductivity of the cooling medium flowing through the cooling piping. Then, when the supply of the conductivity reducing agent to the cooling piping is required, the conductivity reducing agent is supplied to the cooling piping. This scheme enables a decrease in the conductivity of the cooling medium flowing through the cooling piping and enables the conductivity of the cooling medium to be restrained from rising.

The control unit, when the value of the measured conductivity is equal to or larger than a predetermined value, may control the conductivity reducing agent supply unit to supply the cooling piping with the conductivity reducing agent. When the value of the conductivity measured by the conductivity measuring unit is equal to or larger than the predetermined value, the cooling piping is supplied with the conductivity reducing agent. With this scheme, if the conductivity of the cooling medium flowing through the cooling piping is equal to or larger than the predetermined value, it is possible to reduce the conductivity of the cooling medium flowing through the cooling piping and to restrain the rise in the conductivity of the cooling medium.

The conductivity reducing agent may have a hydroxy group. When the cooling piping is supplied with the conductivity reducing agent, the ions contained in the cooling medium flowing via the cooling piping are embraced by the hydroxy groups possessed by the conductivity reducing agent. This scheme enables the decrease in the conductivity of the cooling medium flowing through the cooling piping and enables the conductivity of the cooling medium to be restrained from rising.

The cooling piping may have a protruded portion inwardly. An ion substance produced by embracing the ions with the hydroxy groups possessed by the conductivity reducing agent resides on the protruded portion provided inwardly of the cooling piping. This scheme enables the ion substance to be restrained from flowing within the cooling piping and a flow of the cooling medium flowing through the cooling piping to be maintained.

The cooling apparatus for a fuel cell may further comprise a discharge valve for discharging the cooling medium flowing via the cooling piping, wherein the control unit may, after controlling the conductivity reducing agent supply unit to supply the cooling piping with the conductivity reducing agent, control the discharge valve to discharge the cooling medium flowing via the cooling piping if a predetermined period of time elapses. The cooling piping is supplied with the conductivity reducing agent and, when the predetermined period of time elapses, the cooling medium flowing through the cooling piping is discharged. Then, the ion substance reserved on the protruded portion within the cooling piping is discharged outside the cooling piping. With this scheme, the ion substance reserved on the protruded portion can be restrained from overflowing from on the protruded portion, whereby the hydroxy groups can be restrained from being decoupled from the ions. As a result, the rise in the conductivity of the cooling medium can be restrained.

According to the cooling apparatus of the present invention, the rise in the conductivity of the cooling medium can be restrained.

### BRIEF DESCRIPTION OF THE DRAWINGS

FIG. 1 is a diagram showing an example of a configuration of a cooling system.

FIG. 2 is a schematic diagram in a case where higher alcohols and ions are coupled to form large molecules.

FIG. 3 is a top view of a protruded portion 10.

FIG. 4 is a section view of the protruded portion 10.

FIG. 5 is a view showing in detail an interior of cooling system piping 2 when the higher alcohols are injected into the cooling system piping 2.

FIG. 6 is an explanatory flowchart showing an operation of a cooling system according to a first embodiment.

FIG. 7 is a diagram showing an example of a configuration of the cooling system.

FIG. 8 is an explanatory flowchart showing an operation of the cooling system according to a second embodiment.

FIG. 9 is a diagram showing a relation between a fluctuation of a conductivity of cooling water, opening/closing time of a supply valve 8 of a syringe 6 and opening/closing time of a discharge valve 21.

### DETAILED DESCRIPTION OF THE INVENTION

A best mode (which will hereinafter be termed an embodiment) for carrying out the present invention will hereinafter be described with reference to the drawings. Configurations in the following embodiments are exemplifications, and the present invention is not limited to the configurations in the embodiments.

### First Embodiment

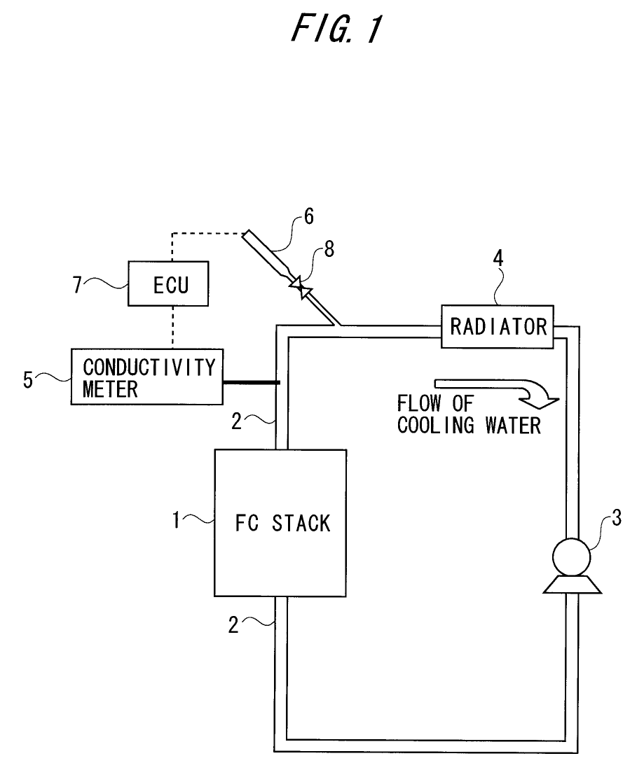

A cooling system according to a first embodiment will hereinafter be described with reference to FIGS. 1 through 6. FIG. 1 is a diagram showing an example of a configuration of the cooling system of a fuel cell mounted on a mobile object such as mainly a fuel cell vehicle.

In FIG. 1, the cooling system according to the first embodiment includes a fuel cell stack 1, cooling system piping 2 via which cooling water circulates, a water pump 3 that circulates the cooling water, a radiator 4 that radiates heat of the cooling water into an outside air, a conductivity meter 5 for measuring a conductivity (an electrical conductivity) of the cooling water, a syringe 6 that injects a water solution into the cooling system piping 2, and an electronic control unit (ECU) 7 that is electrically connected to the conductivity meter 5 and to the syringe 6. In the first embodiment, the cooling water is circulated through the cooling system piping 2, however, in addition to the cooling water, a cooling medium such as a liquid coolant and a cooling system coolant may also be used.

The fuel cell stack 1 is constructed of a plurality of stacked cells. Each cell is composed of an electrolyte film, an anode (fuel electrode), a cathode (air electrode) and a separator. Flow paths for hydrogen and air are formed between the anode and the cathode.

In the anode of the fuel cell stack 1, when supplied with an anode gas, hydrogen ions are generated from hydrogen contained in the anode gas. Further, the cathode of the fuel cell stack 1 is supplied with oxygen contained in the air. Then, in the fuel cell stack 1, electrochemical reaction of hydrogen and oxygen occurs, and electric energy is generated. Moreover, in the cathode of the fuel cell stack 1, the hydrogen ions generated from hydrogen are coupled with oxygen, thereby generating water.

An internal path, via which the cooling water is circulated, is formed in an interior of the separator of the fuel cell stack 1. The cooling water is circulated via the internal path of the fuel cell stack 1, whereby the fuel cell stack 1 reaching a high temperature due to the heat generated when the power generation occurs can be cooled off.

The cooling water, which has passed through the internal path of the fuel cell stack 1 and has come to the high temperature, flows into the cooling system piping 2. The cooling water flowing into the cooling system piping 2 is supplied to the radiator 4 and cooled off by the outside air. The cooling water passing through the radiator 4 and cooled down to a low temperature is fed to the water pump 3. As the water pump 3 is driven, the cooling water flowing through the cooling system piping 2 flows again into the internal path of the fuel cell stack 1. Accordingly, the cooling water circulates through the internal path of the fuel cell stack 1 and through the cooling system piping 2.

The ions coming from an inner wall of the internal path of the fuel cell stack 1 and from an inner wall of the cooling system piping 2 get eluted into the cooling water flowing through the internal path of the fuel cell stack 1 and through the cooling system piping 2. When the ions get eluted into the cooling water, the conductivity of the cooling water rises. The conductivity meter 5 periodically measures the conductivity of the cooling water flowing through the cooling system piping 2. The conductivity meter 5 corresponds to a conductivity measuring unit according to the present invention.

The water solution, which reduces the conductivity of the cooling water, is retained in an interior of the syringe 6. The water solution corresponds to a conductivity reducing agent according to the present invention. Further, the syringe 6 is connected to the cooling system piping 2. The syringe 6 is driven to open a supply valve 8 of the syringe 6, with the result that the water solution is injected into the cooling system piping 2. When the water solution is injected into the cooling system piping 2, the water solution gets mixed with the cooling water flowing through the cooling system piping 2. The syringe 6 corresponds to a conductivity reducing agent supply unit according to the present invention.

The electronic control unit 7 controls the drive of the syringe 6. To be specific, the electronic control unit 7 transmits an instruction signal for injecting the water solution into the cooling system piping 2 to the syringe 6. The syringe 6, when receiving the instruction signal for injecting the water solution into the cooling system piping 2, opens the supply valve 8 and injects the water solution into the cooling system piping 2. Further, the electronic control unit 7 acquires a value of the conductivity of the cooling water measured by the conductivity meter 5. The electronic control unit 7 corresponds to a control unit according to the present invention.

Given next is an in-depth description of a case in which the water solution retained in the interior of the syringe 6 is injected into the cooling system piping 2.

The water solution retained in the interior of the syringe 6 is a water solution having a hydrophilic group and a hydrophobic group together. The water solution having the hydrophilic group and the hydrophobic group together is exemplified by a higher alcohol (CnH₂ₙ₊₁OH). In the first embodiment, the water solution retained in the interior of the syringe 6 involves using the higher alcohol. The higher alcohol used in the first embodiment is an exemplification, and other available alcohols are butanol and propanol.

The ions, which have got eluted into the cooling water from the inner wall of the internal path of the fuel cell stack 1 and the inner wall of the cooling system piping 2, as the water pump 3 is driven, flow together with the cooling water through the internal path of the fuel cell stack 1 and through the cooling system piping 2.

When the higher alcohol is injected into the cooling system piping 2 from the syringe 6, the higher alcohol gets mixed with the cooling water flowing through the cooling system piping 2. The higher alcohol mixed with the cooling water gets close while directing a hydroxy group as the hydrophilic group to the ions that have got eluted into the cooling water. The ions, which have got eluted into the cooling system piping 2, are positive ions (cations), and the higher alcohol, because of the hydroxy group being large in its electric polarization, gets close in a way that directs the hydroxy group to the ions becoming eluted into the cooling water. Then, the hydroxy groups are arranged in the periphery of the ions, and the ions are surrounded with the higher alcohols, thereby forming large molecules. Namely, the hydroxy groups of the higher alcohols surround the ions and salting-out is conducted, resulting in generation of an ion substance (which is also referred to as a clot) composed of the higher alcohol and the ions.

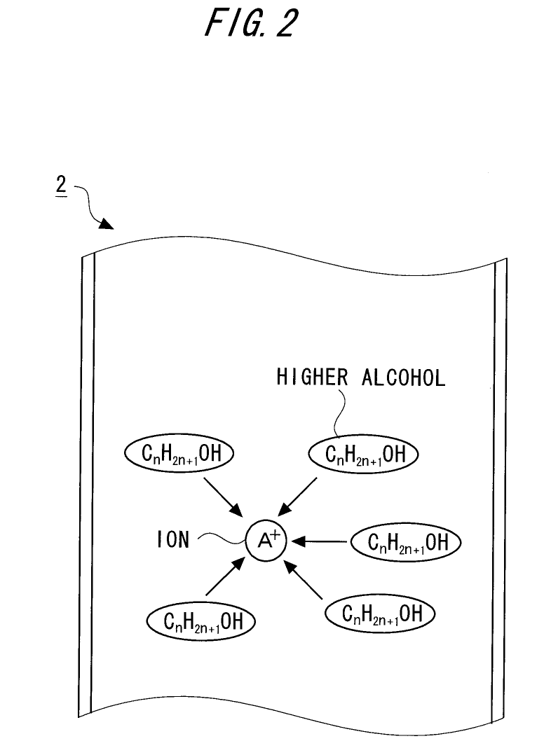

The higher alcohols surround the peripheries of the ions getting eluted into the cooling water, and hence the ions do not get exposed, whereby the conductivity of the cooling water decreases. It is therefore feasible to restrain a rise in the conductivity of the cooling water, which is caused by the ion elution into the cooling water from the inner wall of the internal path of the fuel cell stack 1 and from the inner wall of the cooling system piping 2. The higher alcohols surround the peripheries of the ions getting eluted into the cooling water, whereby the ions become the large molecules and flow together with the cooling water through the cooling system piping 2. FIG. 2 shows a schematic diagram in a case where the higher alcohol injected into the cooling system piping 2 gets close in a way that directs the hydroxy groups to the ions becoming eluted into the cooling water and the large molecules are formed.

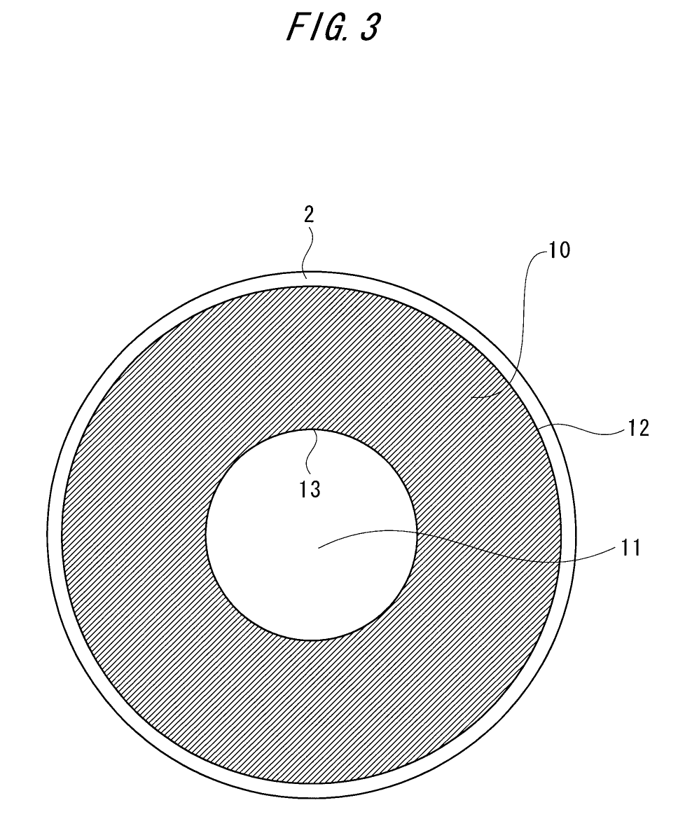

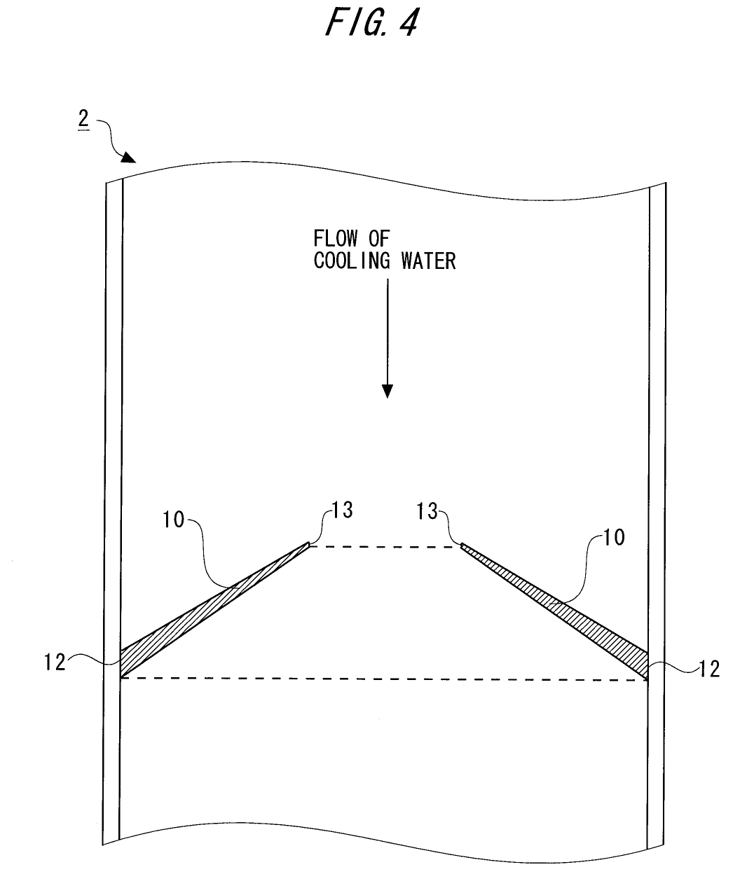

Next, a protruded portion 10 provided inside the cooling system piping 2 will be described in detail with reference to FIGS. 3 and 4.

FIG. 3 is a top view of the protruded portion 10. The protruded portion 10 takes a shape in which a central area 11 is cut out, and the cooling water passes via the central area 11 of the protruded portion 10. Further, the protruded portion 10 has an outer periphery 12 taking substantially a circular shape and an inner periphery 13 taking likewise substantially the circular shape. These shapes are, however, exemplifications, and the shape of the protruded portion 10 is not limited to those given above.

FIG. 4 is a sectional view of the protruded portion 10. In the protruded portion 10, the inner periphery 13 is protruded in a cooling water flowing direction to a greater degree than the outer periphery 12. Then, the outer periphery 12 of the protruded portion 10 is bonded to the inner wall surface of the cooling system piping 2.

The plurality of protruded portions 10 is provided at a predetermined interval within the cooling system piping 2. The number of the protruded portions 10 maybe selected based on a length of the cooling system piping 2.

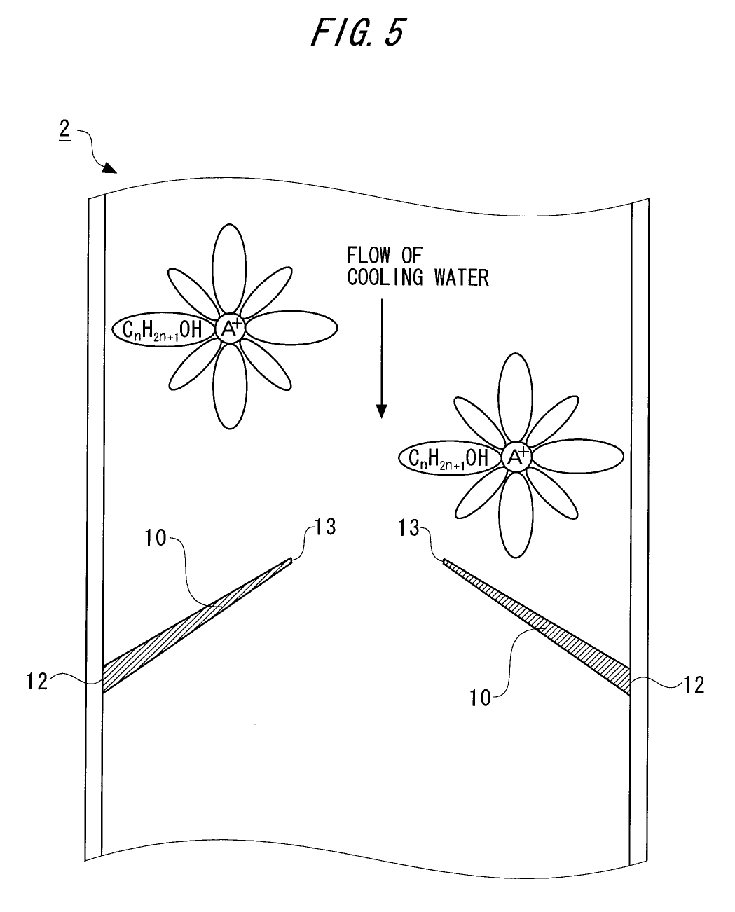

FIG. 5 shows a detailed illustration of an interior of the cooling system piping 2 when the higher alcohol is injected into the cooling system piping 2. The ion is coupled with the higher alcohol to become part of the large molecules. As illustrated in FIG. 5, the inner periphery 13 of the protruded portion 10 is protruded in the cooling water flowing direction, and hence the protruded portion 10 has a gradient toward the outer periphery 12 bonded to the inner wall surface of the cooling system piping 2 from the inner periphery 13. An angle of the gradient of the protruded portion 10 to the inner wall surface of the cooling system piping 2 is set arbitrary and, for example, the angle of the gradient of the protruded portion 10 to the inner wall surface of the cooling system piping 2 may be set at 90 degrees.

If the large molecules composed of the ions and the higher alcohols collide with the protruded portion 10, the large molecules reside on the surface of the protruded portion 10. Therefore, neither the large molecules residing on the surface of the protruded portion 10 nor the ions serving as part of the large molecules flow via the cooling system piping 2.

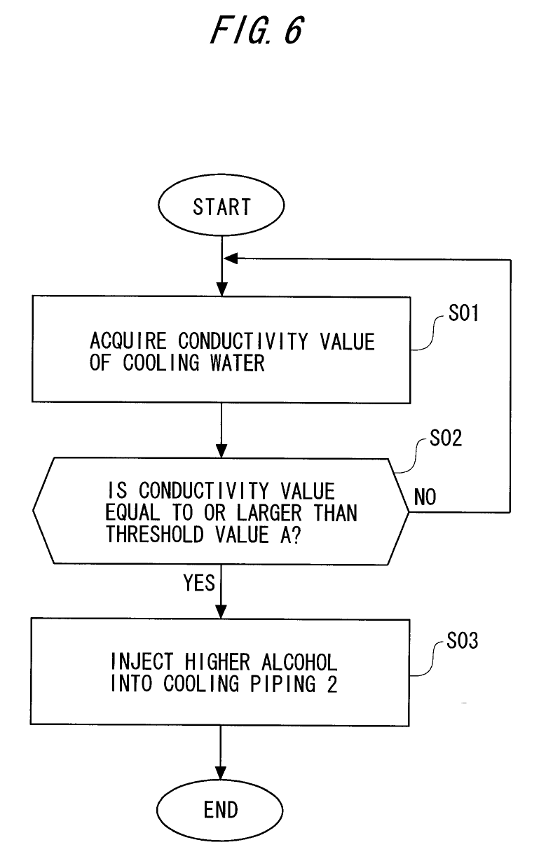

FIG. 6 is an explanatory flowchart showing an operation of the cooling system according to the first embodiment. The cooling water circulates through the internal path of the fuel cell stack 1 and through the cooling system piping 2 (as when the fuel cell generates the power), during which the cooling system according to the first embodiment operates. To be specific, when the cooling water circulates through the internal path of the fuel cell stack 1 and through the cooling system piping 2 (as when the fuel cell generates the power), electronic control unit 7 executes processes shown in FIG. 6.

To begin with, the electronic control unit 7 acquires a value of the conductivity of the cooling water, which has been measured by the conductivity meter 5 (S01).

Next, the electronic control unit 7 determines whether or not the value of the conductivity of the cooling water, which has been measured by the conductivity meter 5, is equal to or larger than a threshold value A (S02). The threshold value A is a preset value for restraining occurrence of an electric leak if the conductivity of the cooling water rises, and may be obtained empirically or by simulation.

If the value of the conductivity of the cooling water, which has been measured by the conductivity meter 5, is not equal to or larger than the threshold value A (a negative case in the process in S02), the electronic control unit 7 returns to the process in S01. In this case, the electronic control unit 7 may get back to the process in S01 after an elapse of a predetermined period of time.

Whereas if the value of the conductivity of the cooling water, which has been measured by the conductivity meter 5, is equal to or larger than the threshold value A (an affirmative case in the process in S02), the electronic control unit 7 controls the drive of the syringe 6 so as to inject the higher alcohol into the cooling system piping 2 (S03). A specific method of how the drive of the syringe 6 is controlled will be explained. The control of the drive of the syringe 6 is not, however, limited to the following description of a method (1) or a method (2), and other types of drive control may be adopted.

(1) The electronic control unit 7 transmits, to the syringe 6, an instruction signal for injecting the higher alcohol into the cooling system piping 2 a predetermined number of times. In the case of injecting the higher alcohol into the cooling system piping 2 the predetermined number of times, the electronic control unit 7 transmits, to the syringe 6, the instruction signal for injecting the higher alcohol into the cooling system piping 2 at a predetermined time interval. The syringe 6 injects the higher alcohol into the cooling system piping 2 in accordance with the instruction received from the electronic control unit 7. When the drive of the syringe 6 is thus controlled, it follows that the higher alcohol is injected into the cooling system piping 2 the predetermined number of times at the predetermined time interval. The drive of the syringe 6 is stopped just when injecting the higher alcohol into the cooling system piping 2 the predetermined number of times.

(2) The electronic control unit 7 transmits, to the syringe 6, the instruction signal for injecting the higher alcohol into the cooling system piping 2 at the predetermined time interval. The syringe 6 injects the higher alcohol into the cooling system piping 2 according to the instruction received from the electronic control unit 7. Further, the electronic control unit 7 acquires the value of the conductivity of the cooling water, which has been measured by the conductivity meter 5, from this conductivity meter 5. The electronic control unit 7 transmits to the syringe 6, if the value of the conductivity of the cooling water is less than the threshold value A, an instruction signal for stopping the injection of the higher alcohol into the cooling system piping 2. Then, the syringe 6 stops injecting the higher alcohol into the cooling system piping 2. When the drive of the syringe 6 is thus controlled, it follows that the higher alcohol is injected into the cooling system piping 2 till the value of the conductivity of the cooling water becomes less than the threshold value A.

In the first embodiment, if the conductivity of the cooling water becomes equal to or larger than the threshold value A, the higher alcohol is injected into the cooling system piping 2. When the higher alcohol is injected into the cooling system piping 2, the ions getting eluted into the cooling water and the higher alcohols are combined to form the large molecules. The ions becoming part of the large molecules do not get exposed to the cooling water, and therefore the conductivity of the cooling water decreases, and the conductivity of the cooling water is restrained from rising.

Further, in the first embodiment, the protruded portion 10 provided on the inner wall surface of the cooling system piping 2 captures the large molecules, thereby restraining the large molecules from flowing through the internal path of the fuel cell stack 1 and through the cooling system piping 2. To be specific, the large molecules are made to reside on the surface of the protruded portion 10 and are thereby restrained from flowing through the internal path of the fuel cell stack 1 and through the cooling system piping 2. When the large molecules flow through the cooling system piping 2, the flow of the cooling water via the cooling system piping 2 is deteriorated. According to the first embodiment, the large molecules are restrained from flowing through the cooling system piping 2, thereby enabling the flow of the cooling water flowing through the cooling system piping 2 to be kept in a highly acceptable state.

Further, the large molecules flow via the cooling system piping 2, during which the higher alcohols are decoupled from the ions, and the ions might be exposed. If the ions get exposed, the conductivity of the cooling water rises. According to the first embodiment, the large molecules are restrained from flowing through the cooling system piping 2, and it is therefore feasible to restrain the ions from being exposed due to the flow of the large molecules through the cooling system piping 2. As a result, the conductivity of the cooling water can be restrained from rising.

### Second Embodiment

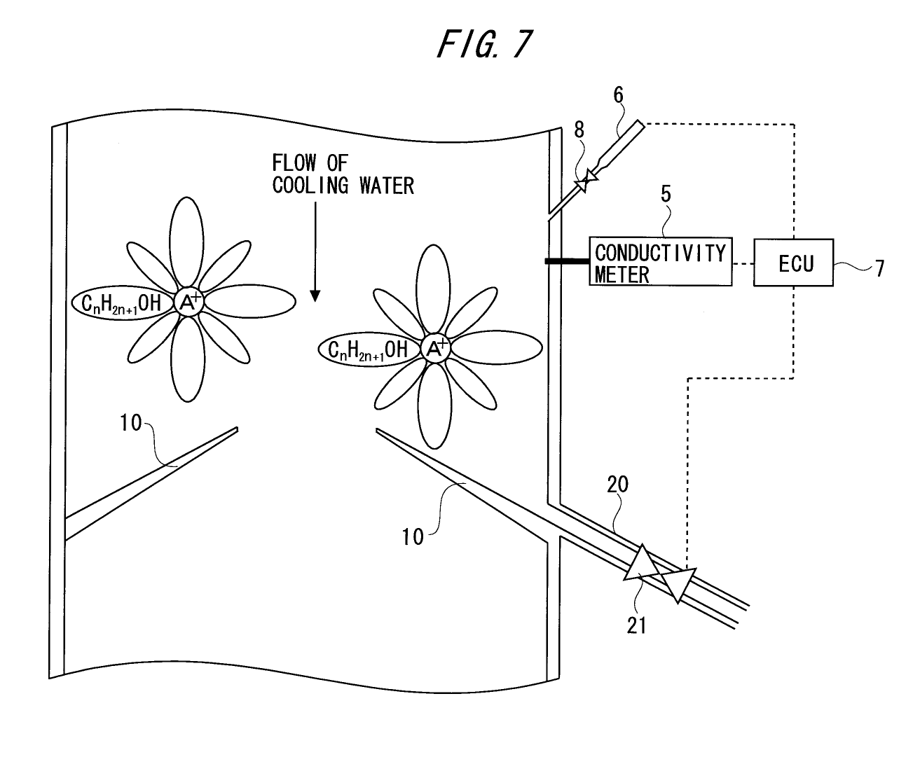

Next, the cooling system according to a second embodiment will be described. The same portions as those in the first embodiment discussed above are marked with the same numerals and symbols, and their detailed descriptions are omitted. In the cooling system according to the second embodiment, as illustrated in FIG. 7, the cooling system piping 2 is provided with a discharge pipe 20, and the discharge pipe 20 is provided with a discharge valve 21. The discharge pipe 20 is provided substantially in parallel with the angle of the gradient of the protruded portion 10. Then, the surface of the protruded portion 10 is connected to part of the inner wall surface of the discharge pipe 20. In FIG. 7, the discharge pipe 20 and the discharge valve 21 are provided on a one-by-one basis with respect to the protruded portion 10 and may also be provided on a plurality-by-plurality basis with respect to the protruded portion 10.

The electronic control unit 7 is electrically connected to the discharge valve 21 and controls drive of the discharge valve 21. Namely, the electronic control unit 7 transmits, to the discharge valve 21, an instruction signal for opening or closing the discharge valve 21.

When the discharge valve 21 receives the instruction signal for opening the discharge valve 21 and opens, some proportion of the cooling water flowing through the cooling system piping 2 flows via the discharge pipe 20 and is discharged outside the cooling system piping 2.

When the higher alcohols are injected into the cooling system piping 2 and when the large molecules composed of the ions and the higher alcohols are formed, the large molecules flow together with the cooling water through the cooling system piping 2. Then, the large molecules, when colliding with the protruded portion 10, reside on the surface of the protruded portion 10. Further, when the large molecules flowing through the cooling system piping 2 collide with the large molecules residing on the surface of the protruded portion 10, the large molecules colliding with the large molecules residing on the surface of the protruded portion 10 further reside thereon. Namely, the large molecules flowing via the cooling system piping 2 continuously reside on the protruded portion 10 in the cooling water flowing direction.

When a predetermined quantity of large molecules reside on the protruded portion 10, however, the large molecules flowing in hereafter do not reside thereon but flow via the cooling system piping 2. Namely, due to an overflow of the large molecules that are disabled from residing on the protruded portion 10, the large molecules flow via the cooling system piping 2. When the large molecules flow through the cooling system piping 2, the flow of the cooling water is deteriorated. Further, the large molecules flow via the cooling system piping 2, during which the higher alcohols are decoupled from the ions, and the ions might be exposed. If the ions get exposed, the conductivity of the cooling water rises.

In the second embodiment, the cooling system piping 2 is provided with the discharge pipe 20, and the discharge pipe 20 is provided with the discharge valve 21. Then, the large molecules residing on the protruded portion 10 are discharged together with the cooling water from the discharge pipe 20 by opening the discharge valve 21. Thereafter, the discharge valve 21 is closed. The overflow of the large molecules disabled from residing on the protruded portion 10 is restrained by properly opening or closing the discharge valve 21.

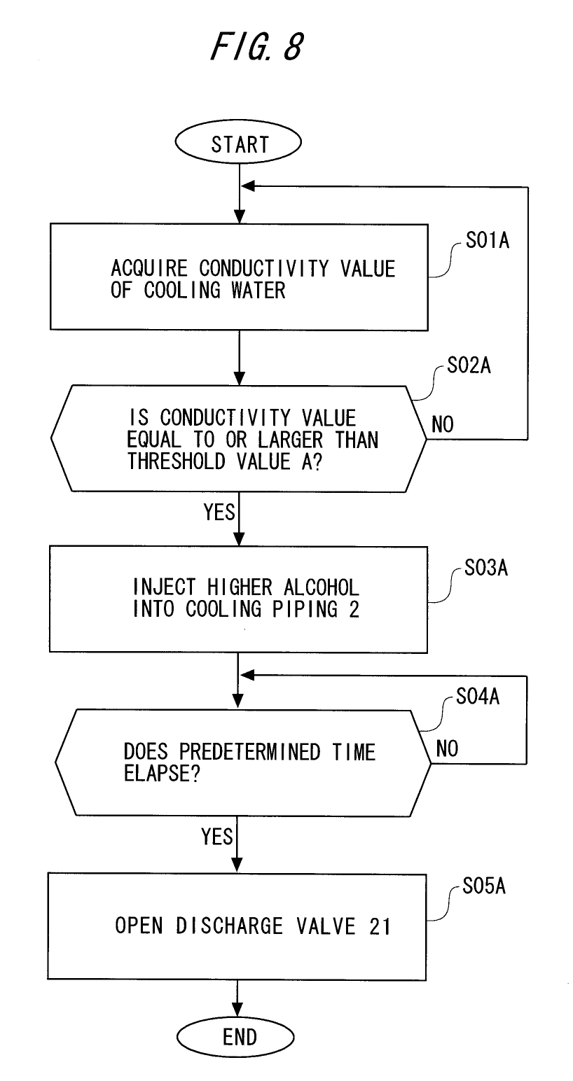

FIG. 8 is an explanatory flowchart showing an operation of the cooling system according to the second embodiment. The cooling water circulates through the internal path of the fuel cell stack 1 and through the cooling system piping 2 (as when the fuel cell generates the power), during which the cooling system according to the second embodiment operates. To be specific, when the cooling water circulates through the internal path of the fuel cell stack 1 and through the cooling system piping 2 (as when the fuel cell generates the power), electronic control unit 7 executes processes shown in FIG. 8.

Processes in S01A through S03A are the same as those in the first embodiment, and hence the in-depth descriptions thereof are omitted. Accordingly, processes in S04A through S05A in FIG. 8 will be explained. The syringe 6 is driven, and the higher alcohol is injected into the cooling system piping 2, in which case the electronic control unit 7, after the syringe 6 has finished injecting the water solution into the cooling system piping 2 in the process in S03A, determines whether a predetermined period of time elapses or not (S04A).

If the predetermined period of time does not yet elapse (a negative case in the process in S04A), the electronic control unit 7 repeats the process in S04A.

Whereas if the predetermined period of time elapses (an affirmative case in the process in S04A), the electronic control unit 7 transmits an instruction signal for opening/closing the discharge valve 21 to the discharge valve 21, thus controlling the drive of the discharge valve 21 (S05A). For example, the electronic control unit 7 transmits an instruction signal for opening/closing the discharge valve 21 a predetermined number of times to the discharge valve 21. In the case of transmitting the instruction signal for opening/closing the discharge valve 21 the predetermined number of times, the electronic control unit 7 transmits an instruction signal for opening/closing the discharge valve 21 at a predetermined time interval to the discharge valve 21. If the drive of the discharge valve 21 is thus controlled, the large molecules residing on the protruded portion 10 can be discharged outside the cooling system piping 2.

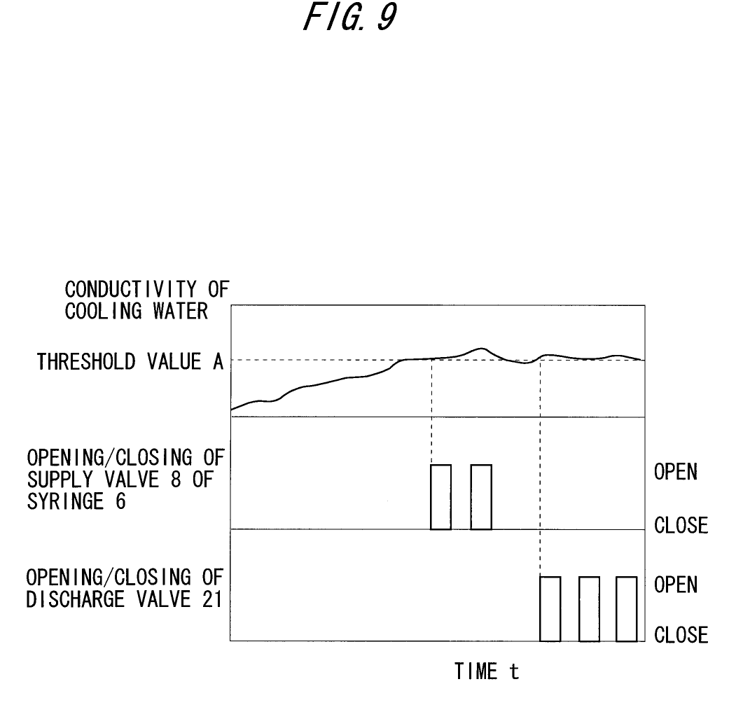

FIG. 9 shows a relation between a fluctuation of the conductivity of the cooling water, opening/closing time of the supply valve 8 of the syringe 6 and opening/closing time of the discharge valve 21.

As shown in FIG. 9, the conductivity of the cooling water increases with an elapse of time t. If the conductivity of the cooling water is equal to or larger than the threshold value A, the supply valve 8 of the syringe 6 is opened. When the higher alcohols are injected into the cooling system piping 2, the ions are embraced by the higher alcohols, and the conductivity of the cooling water temporarily decreases. In this case, the large molecules formed by embracing the ions with the higher alcohols reside on the protruded portion 10 provided on the inner wall surface of the cooling system piping 2 but do not flow via the cooling system piping 2. Therefore, the conductivity of the cooling water can be restrained from rising in a way that restrains the flow of the cooling water via the cooling system piping 2 from being deteriorated.

Moreover, the large molecules residing on the protruded portion 10 provided on the inner wall surface of the cooling system piping 2 are discharged outside the cooling system piping 2 by opening the discharge valve 21. Hence, the overflow of the large molecules disabled from residing on the protruded portion 10 provided on the inner wall surface of the cooling system piping 2 can be restrained. As a result, it is feasible to restrain decoupling between the ions and the higher alcohols due to the flow of the large molecules via the cooling system piping 2, and by extension the conductivity of the cooling water can be restrained from rising.

### MODIFIED EXAMPLE

In the second embodiment, the large molecules residing on the protruded portion 10 provided on the inner wall surface of the cooling system piping 2 flow to the discharge pipe 20 and are discharged outside the cooling system piping 2. In the present modified example, an acid substance (e.g., acetic acid etc) is flowed to the cooling system piping 2, and the large molecules are hydrolyzed, whereby the large molecules residing on the protruded portion 10 provided on the inner wall surface of the cooling system piping 2 may be removed. In this case, the cooling system piping 2 is detached from the cooling system and may be washed with the acid substance.

### <Others>

The disclosures of Japanese patent application No. JP2007-159156 filed on Jun. 15, 2007 including the specification, drawings and abstract are incorporated herein by reference.

What is claimed is:

1. A cooling apparatus for a fuel cell, comprising:
cooling piping through which a cooling medium for cooling said fuel cell flows;
a conductivity measuring unit measuring a conductivity of the cooling medium that flows through said cooling piping;
a conductivity reducing agent supply unit supplying said cooling piping with a conductivity reducing agent for reducing the conductivity of the cooling medium; and
a control unit controlling said conductivity reducing agent supply unit in accordance with a value of the measured conductivity.

2. The cooling apparatus for the fuel cell according to claim 1, wherein said control unit, when the value of the measured conductivity is equal to or larger than a predetermined value, controls said conductivity reducing agent supply unit to supply said cooling piping with the conductivity reducing agent.

3. The cooling apparatus for the fuel cell according to claim 1 or 2, wherein the conductivity reducing agent has a hydroxy group.

4. The cooling apparatus for the fuel cell according to any one of claims 1 through 3, wherein the cooling piping has a protruded portion inwardly.

5. The cooling apparatus for the fuel cell according to claim 4, further comprising a discharge valve for discharging the cooling medium flowing via said cooling piping,
wherein said control unit, after controlling said conductivity reducing agent supply unit to supply said cooling piping with the conductivity reducing agent, controls said discharge valve to discharge the cooling medium flowing via said cooling piping if a predetermined period of time elapses.
